(19) United States
(12) Patent Application Publication
(10) Pub. No.: US 2015/0083060 A1
(43) Pub. Date: Mar. 26, 2015

(54) COMBUSTION AND VAPOR CYCLE LOBED ROTOR ENGINE

(71) Applicant: Joseph Daniel Best, Newport News, VA (US)

(72) Inventor: Joseph Daniel Best, Newport News, VA (US)

(21) Appl. No.: 14/492,031

(22) Filed: Sep. 21, 2014

Related U.S. Application Data
(60) Provisional application No. 61/881,923, filed on Sep. 24, 2013.

(51) Int. Cl. F02B 25/08; F01B 7/14; F02B 75/20

(52) U.S. Cl. CPC F02B 25/08; F02B 75/20; F01B 7/14; F02B 2075/1808
USPC 123/58.8; 123/59.6

(57) ABSTRACT

An internal combustion engine utilizing an additional vapor expansion piston/cylinder to capture traditionally rejected energy. Hot combustion gases from the combustion process are used to power an additional vapor expansion cycle in a separate cylinder from the combustion cycle. Comprised of at least two pistons/cylinders (one fuel combustion and one vapor expansion) diametrically opposed; where the reciprocal motion of the pistons is transferred to the output shaft via a multiple-lobed rotor assembly.

### CROSS-REFERENCE TO RELATED APPLICATIONS

This application claims the benefit of U.S. Provisional Application No. 61/881,923, filed Sep. 24, 2013.

### BACKGROUND OF THE INVENTION

Since the introduction of the internal combustion engine many improvements have been introduced to increase its efficiency. However, despite its long evolvement, modern day engines are typically only capable of 25% to 40% thermal efficiency, meaning 60% to 75% of the energy of the fuel is rejected. Many attempts have been made to capture the wasted energy and convert it into useful work. Previous efforts have included using additional cycles (within the same cylinder) which use hot combustion gases to convert water/fluid into a vapor; which expand and impart force on the piston producing work. The addition of vapor expansion cycles within the same cylinder introduces lubrication difficulty between the piston and cylinder surfaces, as well as requiring non-standard camshaft designs for valve operation.

Another area of inefficiency is how the piston transfers reciprocal motion to the crankshaft, via the connecting rod, where it is converted to rotational output. As the piston acts on the connecting rod and crankshaft at various angles there is a reduction in efficiency depending on the angle. Alternative designs have been explored to minimize the crank angles and achieve a perpendicular relationship. However, a flaw of the linear engine design is the lack of limiting stops for the piston travel path; as well as a means for starting the engine, without additional complex systems.

### SUMMARY OF THE INVENTION

The present invention comprises an internal combustion engine that consists of at least one fuel combustion piston/cylinder and at least one vapor expansion piston/cylinder that are connected to an individual respective linear connecting rod and act upon a central rotating multiple-lobed rotor assembly. The engine utilizes linear bearing supports, roller bearings, a counter rotating mid-rotor, and springs (or grooved outer rotors) to significantly reduce piston/cylinder side wear and crank angle inefficiencies. The exhausted combustion gases are introduced into the vapor expansion cylinder and are used to provide thermal energy for the vapor expansion cycle.

### BRIEF DESCRIPTION OF THE DRAWINGS

FIG. 1. FIG. 1 illustrates a simplified arrangement of the present invention.

FIG. 2. FIG. 2 (Section of FIG. 1) shows the orientation of the piston/cylinders, compression springs, linear bearing supports, roller bearings, and rotor assembly.

FIG. 3. FIG. 3 depicts the arrangement of the outer rotors, middle rotor, and output shaft.

FIG. 4. FIG. 4 illustrates the arrangement of the rotor assembly, counter rotation shaft, auxiliary shaft, and associated gearing.

FIG. 5. FIG. 5 shows an isometric view of the grooved outer rotors, middle rotor, connecting rod and output shaft.

FIG. 6. FIG. 6 shows a front view of the grooved outer rotors, middle rotor, connecting rod and output shaft.

FIG. 7. FIG. 7 depicts an arrangement of the present invention where multiple cylinder units are arranged lineally about a common output shaft.

FIG. 8. FIG. 8 depicts an arrangement of the present invention where multiple cylinder units are arranged radial about a common rotor assembly and output shaft.

FIG. 9. FIG. 9 illustrates and alternative mode of transferring the piston reciprocal motion to rotary motion via a conventional connecting rod and crank shaft.

### DETAILED DESCRIPTION OF THE INVENTION

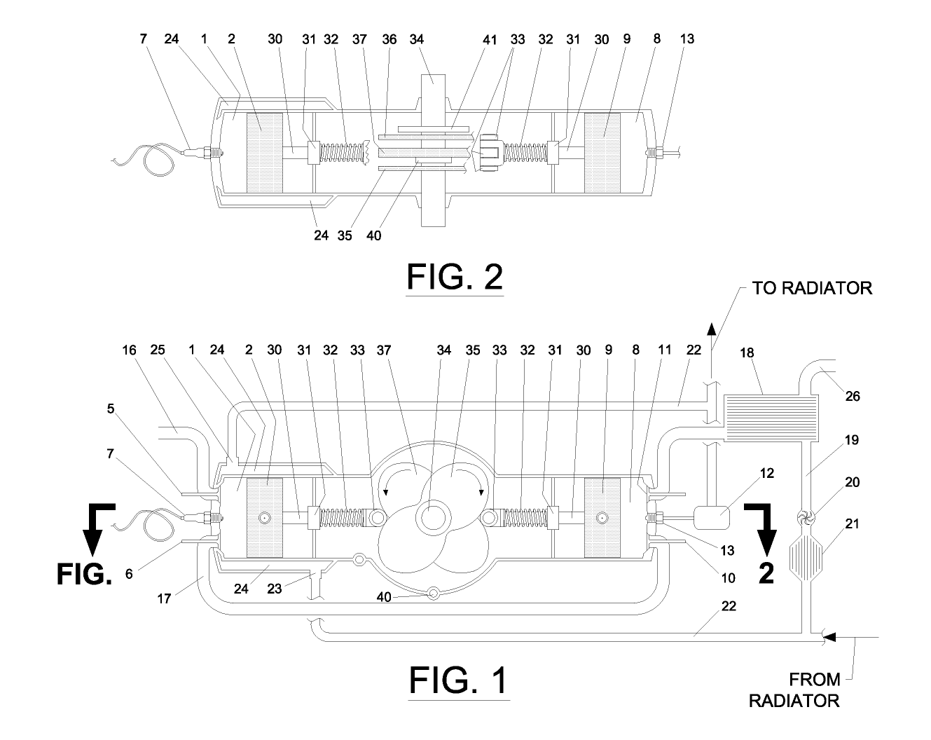

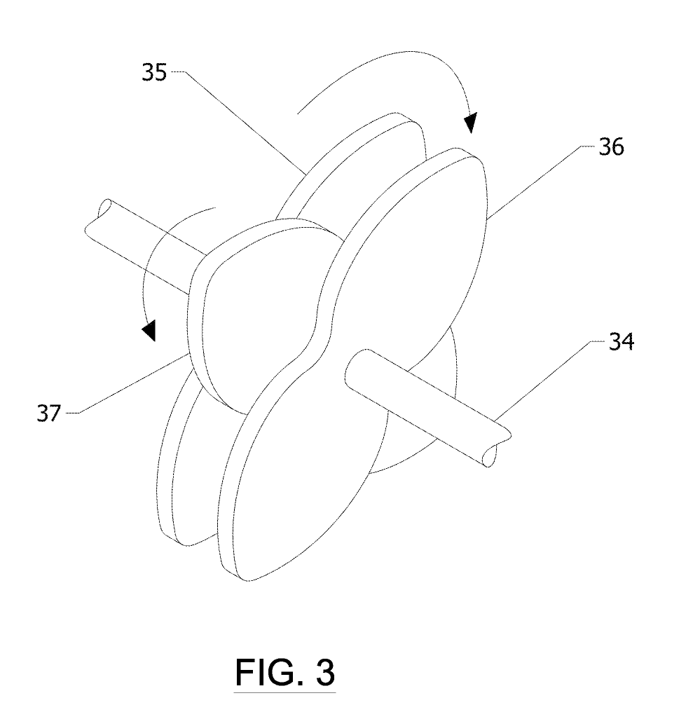

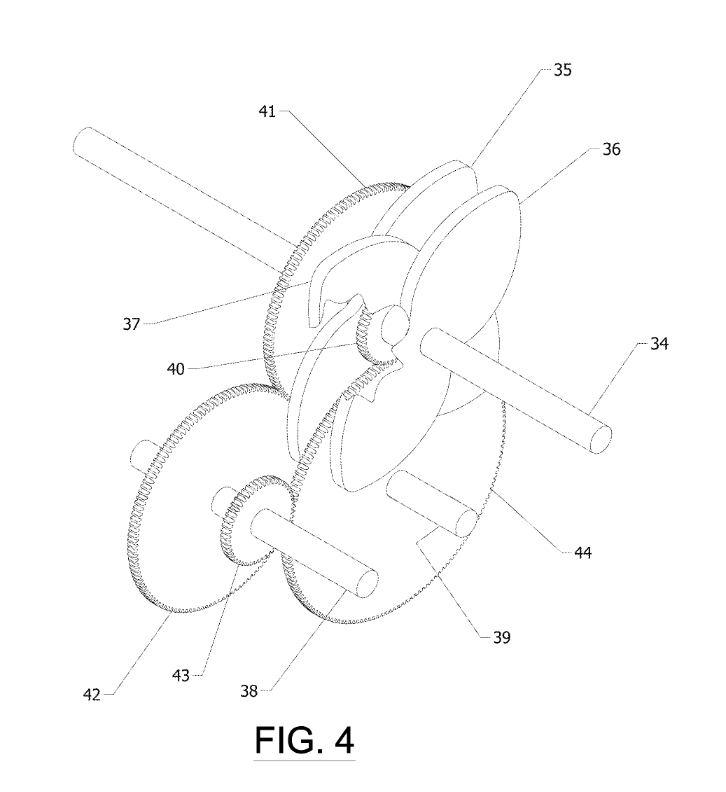

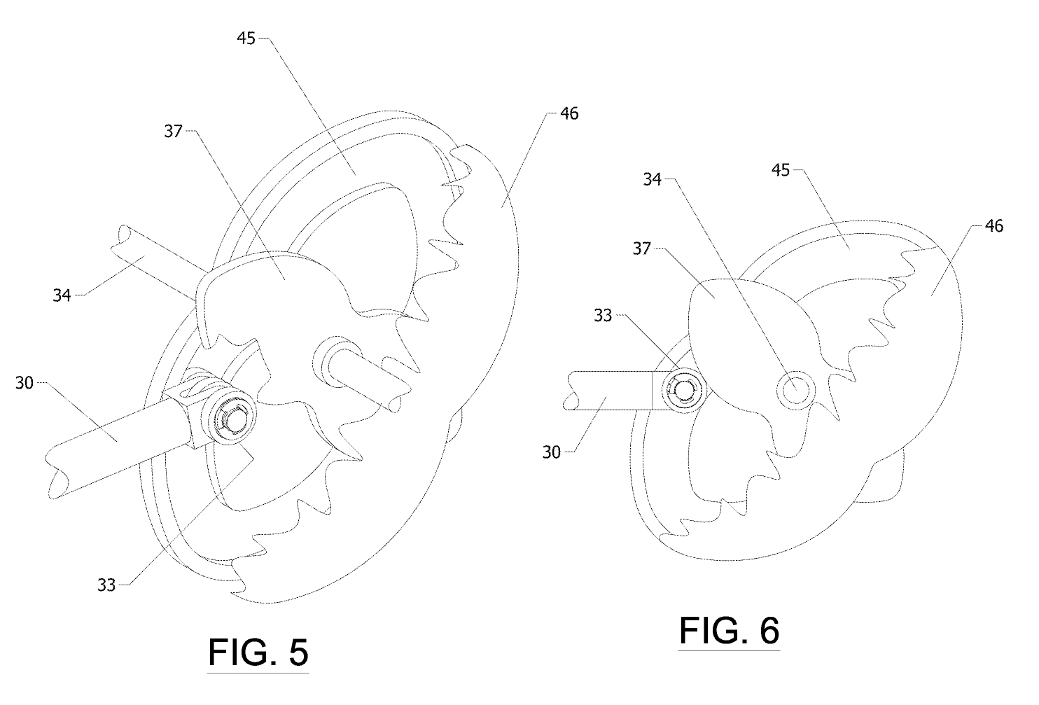

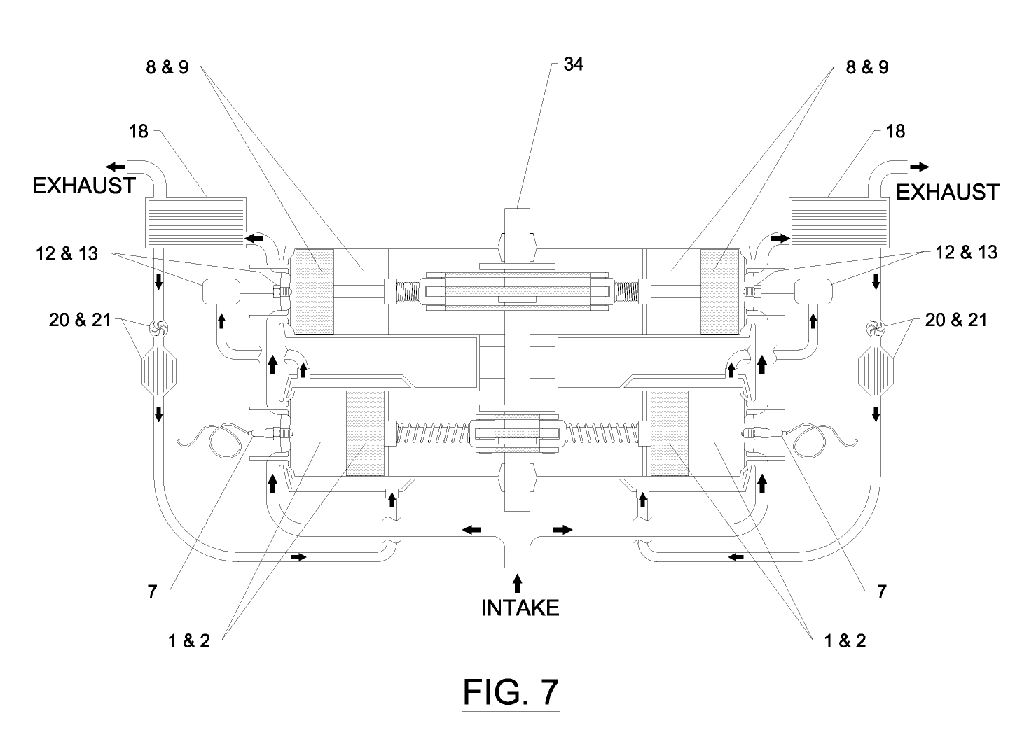

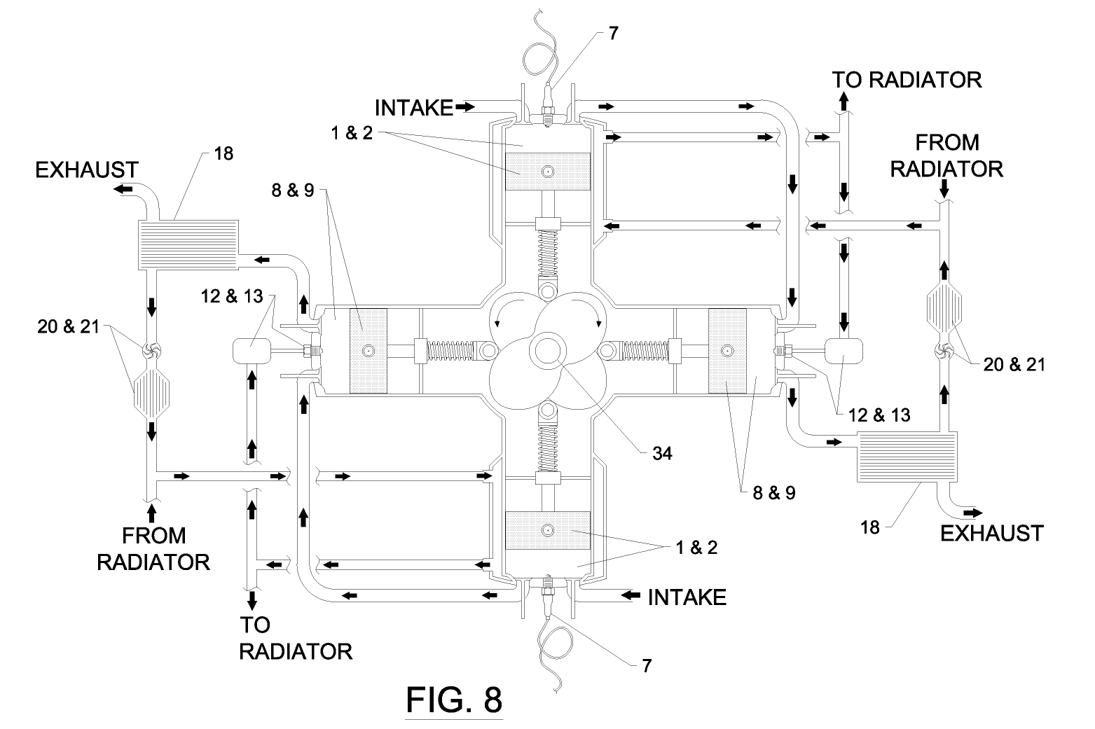

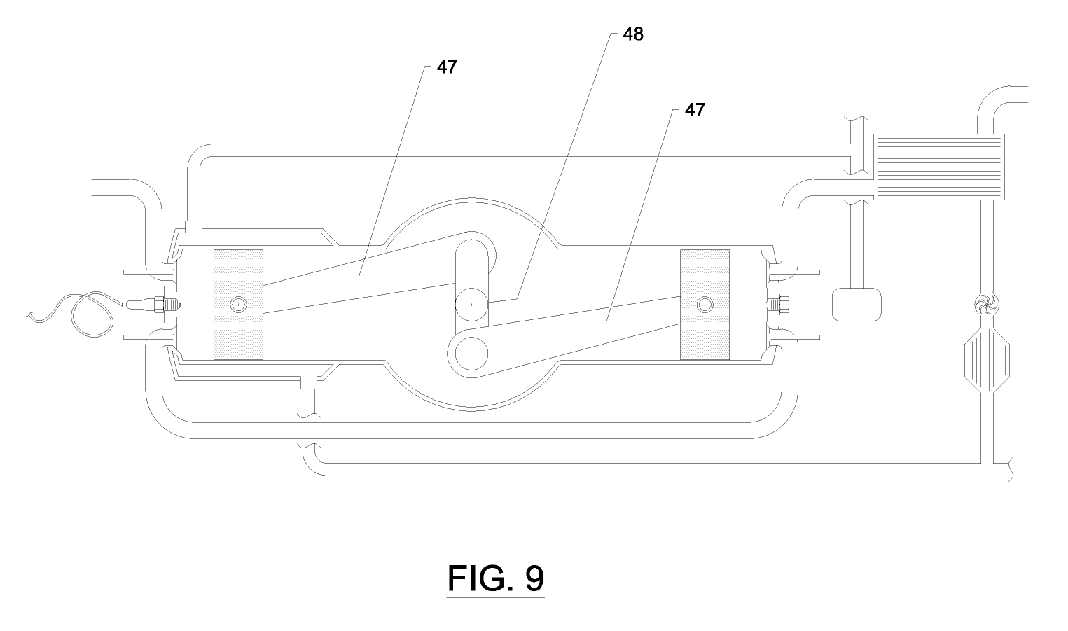

FIG. 1 illustrates a simplified arrangement of the present invention. The gas combustion phase is intended to operate on a cycle similar to the Otto, Diesel, or similar cycle. This description will entail the Otto cycle; however, let it be known that the Diesel cycle or similar is a suitable alternative. The present invention is an internal combustion engine comprised of at least one fuel combustion piston/cylinder (1 & 2) and at least one vapor expansion piston/cylinder (8 & 9) connected to their respectful connecting rod assembly, which operate on a linear path. The pistons travel is limited by the travel path of the compression spring (32) and the rotation of the multiple-lobed rotors (35, 36, & 37). The arrangement of the engine components are contained in a suitable housing that offers both structural support for the components and shafting as well as the appropriate interface for fittings/couplings of the various medium conduits, both rigid and flexible.

First discussing the fuel combustion process, the air/fuel mixture (16) is introduced into the fuel combustion cylinder (1) through the open fuel combustion intake valve (5) as the fuel combustion piston (2) travels away from the fuel combustion intake valve, as acted upon by the compression spring (32), creating a pressure difference. The fuel combustion exhaust valve (6) remains closed during this operation. Once the fuel combustion piston (2) nears the end of the intake stroke, the fuel combustion intake valve (5) moves to the closed position, as it is actuated by a camshaft. The fuel combustion piston (2), reaches the lower limit of the intake stroke as dictated by the travel of the outer multiple-lobed rotor (35), outer multiple-lobed rotor (36), and middle multiple-lobed rotor (37). As the fuel combustion piston travels toward the fuel combustion intake valve (5) and fuel combustion exhaust valve (6), it compresses the air/fuel mixture (16) until it nears the top of the compression stroke where the air/fuel mixture (16) is ignited by the spark plug (7). Both fuel combustion valves (5 & 6) remain closed. The rapidly expanding combustion gas forces the fuel combustion piston (2) away from the spark plug (7). The energy is transferred to the connecting rod (30), rotor roller bearing (33), and finally to the multiple-lobed rotors (35, 36, & 37), where the reciprocal energy is converted to rotary motion.

As the fuel combustion piston (2) approaches the lower limit of the expansion stroke the fuel combustion exhaust valve (6) opens to allow the hot combustion exhaust (17) to escape. The fuel combustion piston (2) travels toward the spark plug (7) removing the combustion exhaust (17) from the fuel combustion cylinder (1). Next discussing the vapor expansion process, on the following stroke, the vapor expansion intake valve (10) opens and the vapor expansion piston (9) travels away from the vapor expansion intake valve (10) filling the vapor expansion cylinder (8) with the hot combustion exhaust (17). The fuel combustion exhaust valve (6) is connected to the vapor expansion intake valve (10) via rigid conduit that is insulated to minimize heat loss. Additionally, the vapor expansion piston (9) is connected to a connecting rod (30) which is acts upon the multiple-lobed rotors (35, 36, & 37).

As the vapor expansion piston (9) nears the lower limit of the intake stroke (as acted upon by the compression spring (32)), the vapor expansion intake valve (10) moves to the closed position as actuated by a camshaft. The vapor expansion exhaust valve (11) remains closed during this operation. As the vapor expansion piston (9) travels toward the vapor expansion intake valve (10) and vapor expansion exhaust valve (11) it compresses the combustion exhaust (17) until it nears the top of the compression stroke where the compressed fluid (22), i.e. water or similar mixture thereof, after being pressurized by the high pressure pump (12), is injected into the vapor expansion cylinder (8) by the water injector (13). Both vapor expansion valves (10 & 11) remain closed. The rapidly expanding vapor (steam) forces the vapor expansion piston (9) away from the water injector (13). The energy is transferred to the connecting rod (30), rotor roller bearing (33), and finally to the multiple-lobed rotors (35, 36, & 37), where the reciprocal energy is converted to rotary motion.

As the vapor expansion piston (9) approaches the lower limit of the expansion stroke the vapor expansion exhaust valve (11) opens to allow the exhaust (26) to escape. The vapor expansion piston (9) travels toward the water injector (13) removing the exhaust (26) from the vapor expansion cylinder (8). The exhaust (26) travels through rigid conduit to the condenser (18) where it is cooled and allowed to condense. The remaining exhaust (26) is emitted from the system.

The cooled condensate (19) is directed to the condensate pump (20) where it is forced through the filter (21) to remove particulates. The purified condensate (19) is then united with the compressed fluid (22) returning from the radiator. The compressed fluid (22) is then directed to the compressed fluid inlet (23) via rigid and/or flexible conduit. The compressed fluid (22) fills the water jacket (24) surrounding the fuel combustion cylinder and 1) removes the excess thermal energy of the combustion process and stores the thermal energy in the compressed fluid (22); 2) preheats the compressed fluid (22) before it is injected into the vapor expansion cylinder (8). The compressed fluid (22) is then directed toward the high pressure pump (12) via rigid and/or flexible conduit. The compressed fluid (22) that cannot be consumed by the vapor expansion process is diverted to a radiator where subsequent cooling occurs.

Let it be known that it may not be practical for the compressed fluid (22) to circulate the water jacket (24) for practical applications. In this situation, it may be reasonable to include a subsequent heat exchanger between a secondary medium (coolant) after it exits the water jacket (24) (at the compressed fluid outlet (25)) and the compressed fluid (22) before it enters the high pressure pump (12).

As the fuel combustion piston (2) and the vapor expansion piston (9) oscillate in their respective cylinders (1 & 8) the energy is converted to rotary motion via the outer multiple-lobed rotor (35), outer multiple-lobed rotor (36), and middle multiple-lobed rotor (37). The middle multiple-lobed rotor (37) is rotating at an equal rate, but opposite direction to the outer multiple-lobed rotors (35 & 36). All multiple-lobed rotors provide positive rotational force to the output shaft (34). The middle multiple-lobed rotor does not directly transfer energy to the output shaft (34), but rather is designed to “free wheel” on the output shaft (34), and transfer energy via the middle rotor gear (40), auxiliary shaft gear (44), auxiliary shaft (39), counter rotation gears (42 & 43), counter rotation shaft (38), and output shaft gear (41) where the energy is transferred to the output shaft (34). The counter rotational middle multiple-lobed rotor is required to produce balanced energy transition between the connecting rod (30) and multiple-lobed rotors (35, 36, & 37), where it cancels the force of the outer multiple-lobed rotors (35 & 36) and allows the sum of the side forces acting on the rotor roller bearing (33) to equal zero. The linear bearing (31) is used to provide stability to the connecting rod (30). The compression spring (32) is used to provide constant contact between the rotor roller bearings (33) and the multiple-lobed rotors (35, 36, & 37). The compression spring (32) is also used to provide energy to the pistons (2 & 9) via the connecting rods (30) to produce the “intake” strokes. However as the cycle speed of the engine is increased it may not be practical to rely solely on energy stored in a mechanical spring to provide the means for an intake strokes. Therefore, a grooved outer rotor (45 & 46) may need to be utilized (or combination of springs and grooved rotors) to provide a limiting boundary to return the pistons (2 & 9) via the connecting rods (30) to perform the “intake” strokes. Alternatively, reciprocal motion from the pistons may be converted to rotary motion via a conventional connecting rod and crankshaft (47 & 48).

Having described my invention, I claim:

1. An internal combustion engine comprising at least one cylinder unit, said cylinder unit comprising:
a shaft having a first (outer) multiple-lobed rotor axially fixed to said shaft, an adjacent second (middle) multiple-lobed rotor differentially geared to said first multiple-lobed rotor for axial counter rotation about said shaft and a third (outer) multiple-lobed rotor axially fixed to said shaft duplicating the first multiple-lobed rotor orientation;
a cylinder set (comprising two cylinders) associated with said multiple-lobed rotors, each cylinder driving a respective side of the multiple-lobed rotors, each cylinder having an axis, the cylinders being diametrically opposed with respect to said shaft with said multiple-lobed rotors interposed there between;
a reciprocating piston in each said cylinder, which said pistons are not rigidly interconnected;
wherein: said multiple-lobed rotors each comprise 2+n lobes where n is zero or an even-numbered integer;
and wherein, reciprocating motion of said pistons in said cylinders imparts rotary motion to said shaft via contact between said pistons and the periphery surfaces of said multiple-lobed rotors.

2. The engine of claim 1, wherein each lobe of the multiple-lobed rotors is symmetrical or asymmetrical governed by the engine cycle employed.

3. The engine of claim 1, wherein the pistons of each cylinder unit, are free to travel independently.

4. The engine of claim 1, wherein the engine operates on the Otto Cycle.

5. The engine of claim 1, wherein the engine operates on the Diesel Cycle.

6. The engine of claim 1, wherein the engine operates on the Atkinson Cycle.

7. The engine of claim 1, wherein the engine operates on the Miller Cycle.

8. The engine of claim 1, comprising from 1 to infinite cylinder units arranged axially in-line along said shaft.

9. The engine of claim 1, comprising from 1 to 4 cylinder sets arranged out of phase by any angle radial to a central multiple-lobed rotor assembly.

10. The engine of claim 1, wherein contact between said pistons and the periphery surfaces of said multiple-lobed rotors is via roller bearing affixed linear connecting rods.

11. The engine of claim 10, wherein said roller bearings have a common axis.

12. The engine of claim 10, wherein said pistons are affixed by said linear connecting rods bounded by spring force.

13. The engine of claim 10, wherein said pistons are affixed by said linear connecting rods bounded by grooved outer rotors.

14. The engine of claim 13, wherein said grooved outer rotors provide inner and outer periphery bounds to said roller bearings

15. The engine of claim 1, the cylinder unit further comprising an auxiliary shaft.

16. The engine of claim 15, wherein said auxiliary shaft is counter rotational of said cylinder unit shaft.

17. The engine of claim 15, wherein said auxiliary shaft provides counter rotation to a further auxiliary shaft.

18. The engine of claim 17, wherein said auxiliary shafts afford means of equal rated counter rotation to said second (middle) multiple-lobed rotor.

19. The engine of claim 1, wherein said auxiliary shafts are driven by the multiple-lobed rotors comprising:
a first gear axially fixed to and power-driven by said cylinder unit shaft in a first direction.
a second gear power-driven by said second (middle) multiple-lobed rotor in a second direction, opposite to the first direction.
a third gear axially fixed to said auxiliary shaft power-driven by said first gear, rotational of the second direction.
a fourth gear axially fixed to said further auxiliary shaft power-driven by said second gear, rotational of the first direction.
a fifth gear axially fixed to said auxiliary shaft in direct connection to said fourth gear.

20. A method of: operating an internal combustion engine;
recovering rejected thermal energy of said internal combustion engine; converting said rejected thermal energy to useful work.

21. The engine of claim 1, further comprising:
a fuel combustion cylinder.
a means to produce an intake, compression, expansion, and exhaust stroke in said combustion cylinder.
a means to introduce fuel and oxidizer into said combustion cylinder.
a means to deflagrate said fuel and oxidizer in said combustion cylinder.
a vapor expansion cylinder.
a means to produce an intake, compression, expansion, and exhaust stroke in said vapor expansion cylinder.
a means to introduce compressed fluid into said vapor expansion cylinder.
a vapor condenser.

22. The engine of claim 21, wherein said combustion cylinder and said vapor expansion cylinder are interconnected via rigid or flexible conduit.

23. The method of claim 20, wherein said combustion cylinder exhaust gas is channeled to said vapor expansion cylinder via said rigid or flexible conduit.

24. The method of claim 20, wherein said combustion cylinder exhaust gas is introduced to said vapor expansion cylinder via said vapor expansion cylinder intake stroke.

25. The method of claim 20, wherein said piston within said vapor expansion cylinder is capable of compressing said combustion cylinder exhaust gas.

26. The method of claim 20, wherein said compressed fluid is injected and converted to vapor in said vapor expansion cylinder.

27. The method of claim 26, wherein said compressed fluid is converted to said vapor via rejected thermal energy from said combustion cylinder exhaust gas.

28. The method of claim 27, wherein said vapor expands, imparting force on said vapor cylinder piston, producing work.

29. The engine of claim 21, wherein said compressed fluid is pressurized via a high pressure pump.

30. The method of claim 20, said compressed fluid is channeled and contained around said combustion cylinder, thus:
removing thermal energy from said combustion cylinder.
increasing the energy content of said compressed fluid.

31. The method of claim 20, said compressed fluid is channeled and contained by a heat exchange device, such that:
a secondary medium is channeled and contained around said combustion cylinder.
said secondary medium removes thermal energy from said combustion cylinder.
energy content of said secondary medium increases.
said secondary medium transfers energy to said compressed fluid via heat exchange device, by means of not intermixing.

32. The method of claim 30, wherein said compressed fluid is driven via a pump of sufficient size such that a flow is obtained.

33. The method of claim 31, wherein said compressed fluid and said secondary medium are driven via pumps of sufficient size such that flows are obtained.

34. The engine of claim 21, wherein said vapor expansion cylinder exhaust is channeled through a vapor condensing device.

35. The engine of claim 33, wherein said vapor condenser is capable of reverting said vapor to condensed fluid phase.

36. The engine of claim 35, wherein said condensed fluid is capable of being recycled as said compressed fluid.

37. The engine of claim 34, wherein said vapor condenser is interconnected to said compressed fluid conduit circuit via rigid or flexible conduit.

38. The engine of claim 37, wherein said compressed fluid conduit contains a filter for removing particulate from said compressed fluid.

39. An internal combustion engine, thus comprising:
a fuel combustion cylinder.
a fuel combustion piston reciprocating in said fuel combustion cylinder.
a means to produce an intake, compression, expansion, and exhaust stroke in said combustion cylinder.
a means to introduce fuel and oxidizer into said combustion cylinder.
a means to deflagrate said fuel and oxidizer in said combustion cylinder.
a vapor expansion cylinder.
a vapor expansion piston reciprocating in said vapor expansion cylinder.
a means to produce an intake, compression, expansion, and exhaust stroke in said vapor expansion cylinder.
a means to introduce compressed fluid into said vapor expansion cylinder.
a vapor condenser.
wherein: reciprocating motion of said pistons is converted to rotary motion via connecting rod and crankshaft.

40. The engine of claim 39, wherein compressed fluid is converted to vapor in said vapor expansion cylinder via rejected thermal energy from said fuel combustion exhaust;
and wherein, said vapor expands imparting force to said vapor expansion piston, producing work.
